(19) United States
(12) Patent Application Publication
(10) Pub. No.: US 2006/0085715 A1
(43) Pub. Date: Apr. 20, 2006

(54) Test board of semiconductor tester having modified input/output printed circuit pattern and testing method using the same

(76) Inventors: Yong-Woon Kim, Chungcheongnam-do (KR); Jeong-Ho Bang, Gyeonggi-do (KR); Hyun-Seop Shim, Incheon Metropolitan City (KR); Woo-Ik Park, Chungcheongnam-do (KR)

Correspondence Address: MARGER JOHNSON & MCCOLLOM, P.C., 210 SW MORRISON STREET, SUITE 400, PORTLAND, OR, 97204, US

(21) Appl. No.: 11/243,053

(22) Filed: Oct. 3, 2005

(30) Foreign Application Priority Data
Oct. 4, 2004 (KR) 2004-78692

(51) Int. Cl. G06F 11/00

(52) U.S. Cl. 714/742

(57) ABSTRACT

A test board for a semiconductor device tester having a modified input/output printed circuit pattern and a testing method using the same are provided. In an embodiment, a modified input/output printed circuit pattern is formed and controlled by a test program, wherein the modified input/output printed circuit pattern is divided into a drive terminal and a comparator terminal, one of the terminals being connected to one input pin of a device under test (DUT) and the other being connected to an output pin of the DUT, unlike a typical input/output printed circuit pattern of the test board that is formed to be connected to one output pin of a DUT. Thus, it is possible to increase the number of devices under parallel test and to test semiconductor memory devices having larger capacity by using limited resources of the tester.

### BACKGROUND OF THE INVENTION

This application claims the priority of Korean Patent Application No. 10-2004-0078692, filed on Oct. 4, 2004, in the Korean Intellectual Property Office, the disclosure of which is incorporated herein in its entirety by reference.

1. Field of the Invention

The present invention relates to a tester used to electrically test semiconductor devices and a testing method and, more particularly, to a test board for connecting devices under test to a tester and a method for testing semiconductor memory devices using the test board.

2. Description of the Related Art

A semiconductor device is produced in a wafer form and is assembled into a semiconductor package. The semiconductor device is finally tested electrically before being distributed to users. In particular, in a semiconductor memory device such as a dynamic random access memory (DRAM), the capacity of the memory device is getting larger and so the number of memory device pins is also getting larger. It becomes increasingly important to enhance test efficiency in an electrical test process as the capacity, speed, and pin number of the semiconductor memory device increases.

To enhance test efficiency, a tester, which is a device for testing semiconductor memory devices, has been developed to increase testing speed. This has been accomplished by the following methods.

A first method is to change a testing method and modify a test program to shorten test time. A second method is to increase the number of semiconductor memory devices tested at a time; i.e., to increase the number of devices under parallel or concurrent test. In the present invention, a test board is modified to effectively operate channels of the tester so that the number of the devices under parallel test is increased, and to have as large a capacity as possible.

FIG. 1 is a block diagram illustrating a conventional art, and FIG. 2 is a flowchart illustrating the same.

Referring to FIGS. 1 and 2, a tester 10, a test board 20, and a handler for automatically loading and sorting devices under test (DUT's) 30A and 30B are required to electrically test such semiconductor devices. The tester includes several other components. In particular, the tester includes channels directly connected to the DUT's 30A and 30B for applying predetermined voltages, currents, and waveforms (clock signals) and receiving response signals to and from the DUT's 30A and 30B.

The number of the test channels is determined according to a standard prescribed by a company fabricating the tester 10. For this reason, the number of the DUT's 30A and 30B that can be parallel-tested at a time in the electric test process is determined by the number of such channels. Generally, the channels may be largely classified into drive channels 16 and input/output channels 18 depending on its functionality.

The drive channel 16 is connected to input pins, for example, A0 through A13 pins, bank active 0 (BA0) through bank active 1 (BA1) pins, a CMD pin as another drive pin, and the like of the DUT's 30A and 30B, and serves to transfer electric signals to the DUT's 30A and 30B via internal drivers 12. Each of the input/output (I/O) channels 18 has a corresponding driver 12 and comparator 14 and can transfer an input signal to the DUT's 30A and 30B and also can receive output signals from the DUT's 30A and 30B.

The test board 20 includes sockets and printed circuit patterns, and acts as an interface for connecting a number of pins of the DUT's 30A and 30B to the channels 16 and 18 of the tester 10.

The DUT's 30A and 30B are loaded on the test board 20 and are connected to the channels of the tester 10 so that unique functions of the DUT's 30A and 30B are tested through an open/short and leakage current test (S10), functional test (S20), speed test (S30), and the like, as shown in FIG. 2. The tested devices are sorted into one of two categories, depending on whether they pass or fail the tests, by a bin sorter or sorting routine S40 and are also sorted/stored by the handler (not shown). The handler is a kind of automatic robotic equipment that transports and sorts the DUT's 30A and 30B into an appropriate bin.

However, if the DUT is, for example, an 8 bit data processing 512M DDR2 SDRAM having 24 input pins and 12 input/output pins, two drive channels are clearly lacking in the conventional tester. As another example, in the electric test process, a parallel test for 64 pins is allowed while a parallel test for 128 pins is not. Continuing with an example where there are insufficient drive channels for the two bank active (BA) pins, as in each of the DUT's 30A and 30B, if the capacity of the DDR2 SDRAM product increases to 1 Gbytes, the electric test is not achievable because memory bank selection is impossible.

### SUMMARY

The present invention provides a test board for a semiconductor device tester having a modified input/output printed circuit pattern for allowing the number and memory capacity of DUT's to increase by securing an additional number of drive channels through modification of the test board.

The present invention provides a testing method using a test board for a semiconductor device tester having a modified input/output printed circuit pattern, in which the modified input/output printed circuit pattern allows the number and memory capacity of DUT's to increase by securing additional drive channels via modification of the test board.

According to an embodiment of the present invention, there is provided a test board for a semiconductor device tester, including a test board body; a plurality of driver printed circuit patterns disposed in an area of the test board body, each of the plurality of driver printed circuit patterns for connecting a first input pin of a device under test (DUT) to a driver associated with one channel of the tester; and a plurality of input/output printed circuit patterns disposed in another area of the test board body, each of the plurality of input/output printed circuit patterns for connecting a first output pin of the DUT to a driver and a comparator associated with one input/output channel of the tester, in which the input/output printed circuit pattern includes a modified input/output printed circuit pattern divided into a drive terminal and a comparator terminal, the drive terminal being connected to a second input pin of the DUT and the comparator terminal being connected to a second output pin of the DUT.

The semiconductor device can be a dynamic random access memory (DRAM), and the tester can be a system for parallel testing the semiconductor devices.

The input pin of the DUT connected to the modified input/output printed circuit pattern can be a bank active (BA) 2 pin or an on-chip termination (ODT) pin. The output pin of the DUT connected to the modified input/output printed circuit pattern can be a data strobe, e.g. RDQS*, pin.

Preferably, the modified input/output printed circuit pattern is connected to the input/output channel of the tester that uses only a comparator function without using a drive function in a process of testing the semiconductor device.

According to another embodiment of the present invention, there is provided a method for testing semiconductor devices, including forming a modified input/output printed circuit pattern in a test board for a semiconductor device tester; constructing a test program so that a drive terminal of the modified input/output printed circuit pattern is connected to an input pin of the DUT and a comparator terminal thereof is connected to an output pin of the DUT, thereby increasing the capacity of a parallel test of the semiconductor devices by a multiple of 2ⁿ (wherein n is a positive integer) by using the test board and the test program.

According to yet another embodiment of the present invention, there is provided a method for testing semiconductor devices, including forming a modified input/output printed circuit pattern in a test board for a semiconductor device tester; constructing a test program so that a drive terminal of the modified input/output printed circuit pattern is connected to an input pin of the DUT and a comparator terminal thereof is connected to an output pin of the DUT; and testing a product by using the test board and the test program, the product having a semiconductor DUT whose memory capacity is increased by a multiple of 2.

Preferably, using the test program may include constructing a program to assign a single pin of the DUT having two or more different functions to a single corresponding input/output channel of the tester.

According to the present invention, it is possible to increase the number of devices under parallel test and to test semiconductor memory devices having larger capacity by using limited resources of existing semiconductor testing equipment and through the straightforward modification of the test board and the test program.

### BRIEF DESCRIPTION OF THE DRAWINGS

The above and other features and advantages of the present invention will become more apparent by describing in detail exemplary embodiments thereof with reference to the attached drawings.

FIG. 1 is a block diagram illustrating the conventional art.

FIG. 2 is a flowchart illustrating the conventional art.

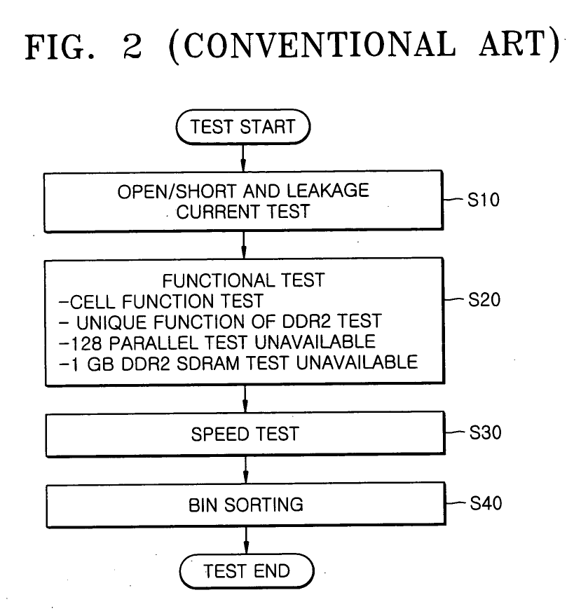

FIG. 3 is a block diagram illustrating a semiconductor device tester according to one embodiment of the invention.

FIG. 4 is a block diagram illustrating connections among a DUT, a test board, and tester channels in a semiconductor device tester.

FIG. 5 is a block diagram illustrating a test board having a modified input/output printed circuit pattern according to the invention.

FIG. 6 is a block diagram illustrating a method in which a modified input/output printed circuit pattern according to the present invention is formed in a test board and then DUT's, such as DRAMs are tested.

FIG. 7 is a flowchart illustrating a testing method using a test board for a semiconductor device tester having a modified input/output printed circuit pattern according to the invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as being limited to the embodiments set forth herein. Rather, these embodiments are provided so that this disclosure will be thorough and complete, and will fully convey the scope of the invention to those skilled in the art. Like numbers refer to like elements throughout the specification.

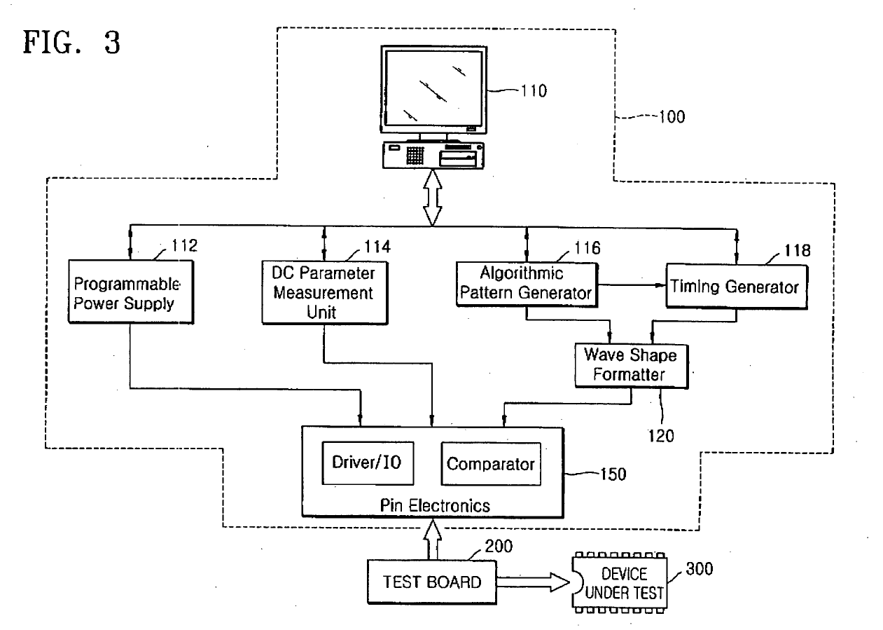

FIG. 3 is a block diagram illustrating a typical semiconductor device tester.

Referring to FIG. 3, a semiconductor device tester 100 has a tester processor 110 for controlling hardware components in the tester. The hardware components include a programmable power supply 112, a DC parameter measurement unit 114, an algorithmic pattern generator 116, a timing generator 118, a wave shape formatter 120, a pin electronics 150, and the like. The pin electronics 150 further includes driver signal channels, input/output signal channels, and a comparator. In the tester 100, a test program running on the tester processor 110 communicates signals and electrically tests functions of the DUT 300 connected via the pin electronics 150 by using a test board 200.

The test program typically includes a DC test, an AC test, and a function test. The function test is to check functions of a semiconductor memory device, for example a DRAM, under its actual operational condition. That is, an input pattern from the algorithmic pattern generator 116 of the tester 100 is written to the DUT 300, for example, the DRAM (write operation), and an output pattern from the DRAM is read out (read operation) and compared to an expected pattern by a comparator (compare operation).

Those of skill in the art will appreciate that there is a large installed base of such expensive semiconductor device testers as those described above. Accordingly, it would be cost-prohibitive and perhaps impossible to force their replacement or upgrade by their manufacturers to higher-pin-testing capacity. The invention provides a third-party solution instead that addresses the problem by modifying the circuit patterns on the much less expensive test board that couples the installed base of device testers to devices under test (DUTs). The invention thus represents a simple and cost-effective yet elegant solution to higher-capacity semiconductor device testing.

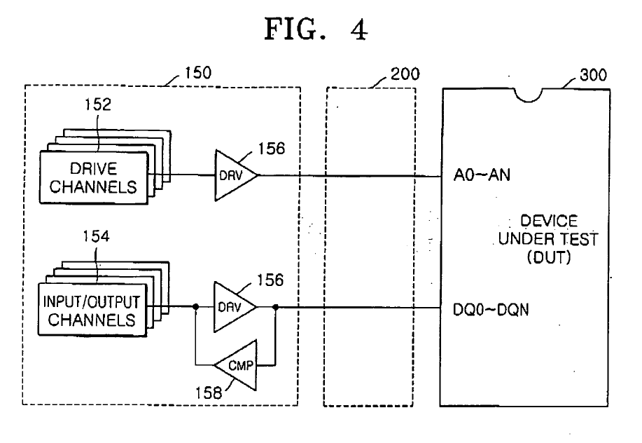

FIG. 4 is a block diagram illustrating connections among a DUT, a test board, and a tester channel in a semiconductor device tester.

Referring to FIG. 4, the pin electronics 150 has a plurality of channels connected to pins of the DUT 300 via the test board 200 in a one-to-one correspondence. The channels of the pin electronics 150 include drive channels 152 and input/output channels 154. The drive channels 152 are connected to input pins, for example, A0 through AN of the DUT 300 in a one-to-one correspondence for applying currents, voltages, and waveforms (clock signals) created from the tester to the DUT. On the other hand, the input/output channels 154 are connected to output pins DQ0 through DQN of the DUT 300 in a one-to-one correspondence for 1) applying currents, voltages, and waveforms (e.g. clock signals) generated by the tester to the DUT 300, and 2) receiving output signals from the DUT 300. Thus, the drive channels 152 are uni-directional and include only a driver 156, while the input/output channels 154 are bi-directional and include both a driver 156 and a comparator 158.

The conventional tester has difficulty increasing the number of the devices under parallel test because of its limited number of drive channels 152 and input/output channels 154.

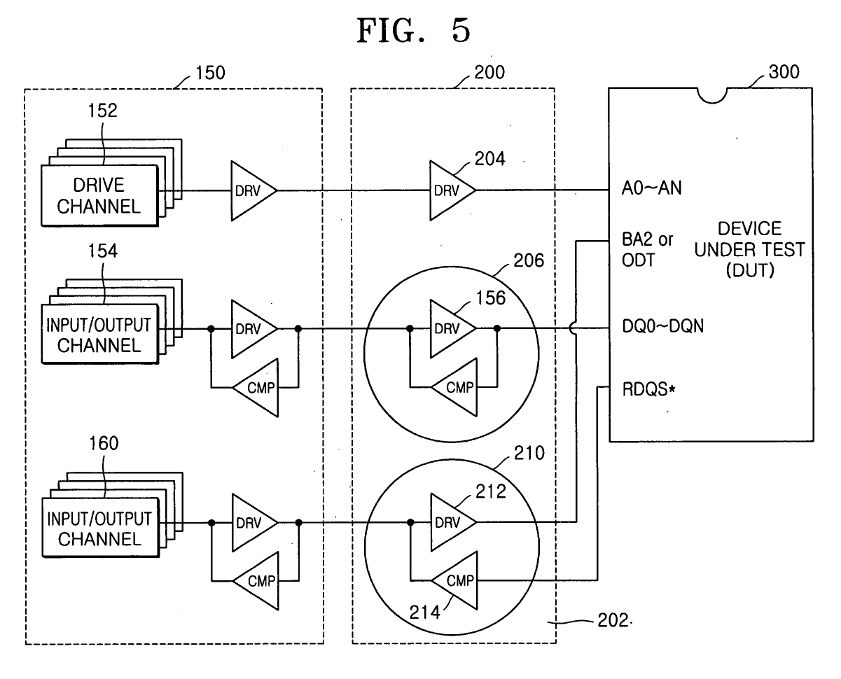

FIG. 5 is a block diagram illustrating a test board 200 for a semiconductor device tester having a modified input/output printed circuit pattern according to the present invention.

The invented test board 200 includes 1) a printed circuit board (PCB)-type test board body 202, 2) a plurality of drive printed circuit patterns 204 disposed in an area of the PCB-type test board body 202 for connecting the input pins A0 through AN of the DUT 300 to the drive channels 152 of the pin electronics 150 in the tester, 3) a plurality of input/output printed circuit patterns 206 disposed in another area of the test board body 202 for connecting the output pins DQ0 through DQN of the DUT 300 to the input/output channels 154 of the pin electronics 150 in the tester, and 4) a modified input/output printed circuit pattern 210 that is divided into a drive terminal 212 and a comparator terminal 214 in the printed circuit pattern of the test board body 202, wherein the drive terminal 212 is connected to an input pin (e.g. bank active 2 BA2 or on-die termination ODT) of the DUT 300, and wherein the comparator terminal 214 is connected to an output pin (e.g. data strobe RDQS*) thereof.

Input/output channels 160 are connected to the modified input/output printed circuit pattern 210 and include the following features. First, in accordance with the invented process of testing a 512 Megabyte (“Mbyte”) or 1 Gbyte (“Gigabyte”) DDR2 SDRAM semiconductor device, for example, the input/output channels 160 are connected to the output pin of the DUT 300, but use only a comparator 214 function without using a driver 212 function. Second, each input/output channel 154 is connected to one output pin of the DUT 300 while the input/output channels 160, connected to the modified input/output printed circuit pattern 210, are connected to the two pins of the DUT 300 having two or more different functions, e.g. BA2/ODT or RDQS*. Any one of the two pins is an input pin, such as the BA2 or ODT pin.

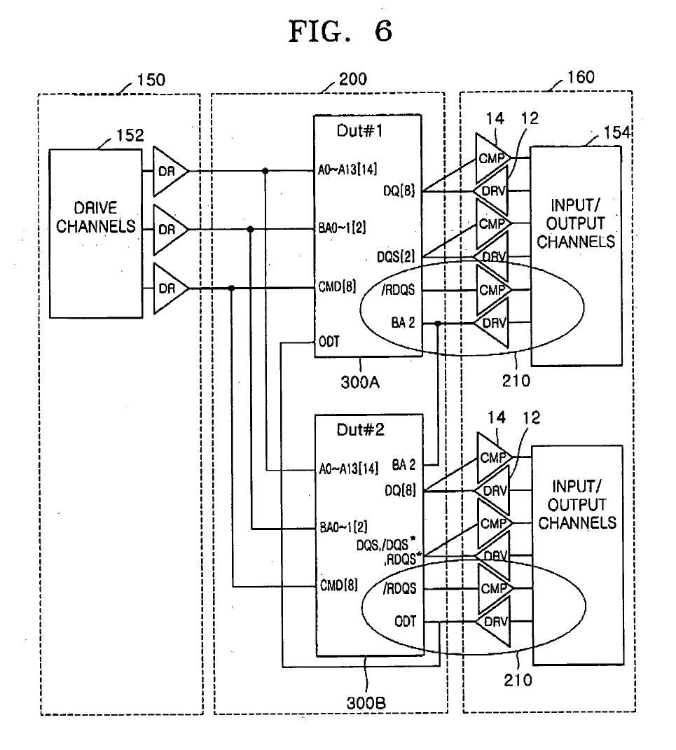

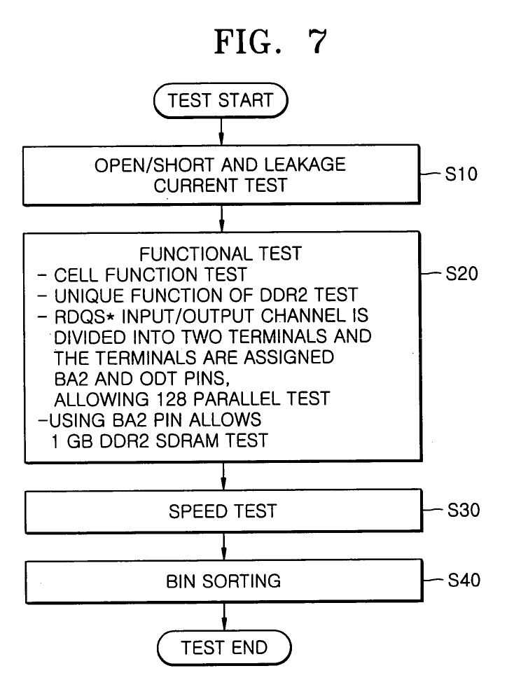

FIG. 6 is a block diagram illustrating a method in which the modified input/output printed circuit pattern, according to an embodiment of the invention, is formed in a test board and then a DUT such as a DRAM is tested thereon. FIG. 7 is a flowchart illustrating a testing method using a test board for a semiconductor device tester having the modified input/output printed circuit pattern according to an embodiment of the invention.

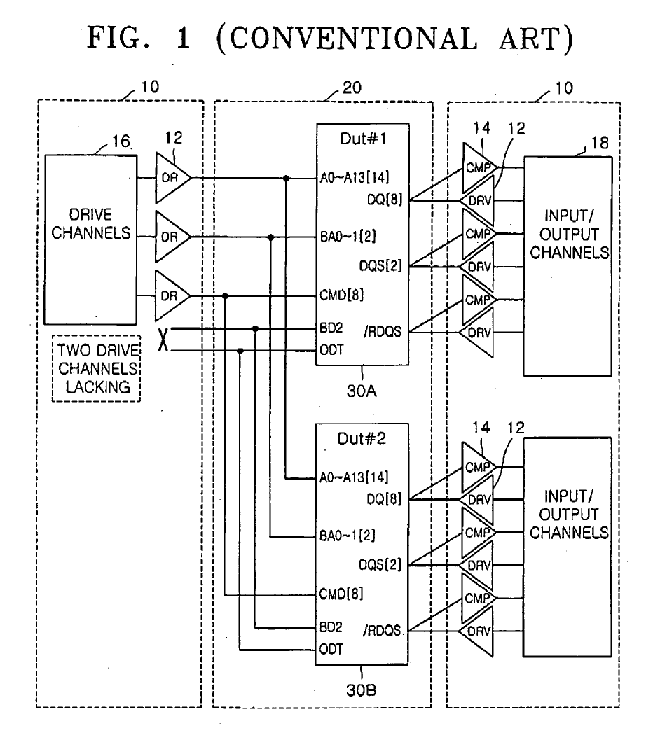

In the conventional tester as shown in FIG. 1, the limited number of drive channels 16 enables a parallel test for only up to 64 pins. A parallel test for up to 128 pins, however, cannot be achieved, conventionally, because there are no drive channels that are secured for the BA2 and ODT pins of the DUT. On the other hand, in the test board 200 of an embodiment of the invention, as shown in FIGS. 5-7, the modified input/output printed circuit pattern 210 is formed and utilized in the input/output printed circuit pattern connected to the RDQS* output pin of the DUT. Accordingly, two drivers are additionally secured and connected to the BA2 and ODT input pins of the DUT's 300A and 300B in common, as shown in FIG. 6.

It may be seen that such is accomplished by forming printed circuit patterns on test board 200 in two groups—a first group in which the DUT pins (e.g. output pins DQ) are connected to a common driver/comparator (shown connected in common) and a second group in which the DUT pins (e.g. one or more output pins RDQS*, one or more input pins BA 2 and one or more input pins ODT) each are connected to a separate comparator and driver that, unlike those of the first group, are not connected in common. This novel scheme effectively multiplies by 2ⁿ (wherein n is a positive integer such as 1), e.g. doubles, the number of testable pins while maintaining the vast installed base of semiconductor device test hardware. This makes it possible to parallel-test 128 or more pins, which is not possible using a conventional tester.

For reference, a K4T51083QM-GXXX 512 Megabyte DDR2 SDRAM, manufactured by SAMSUNG ELECTRONICS CO. LTD., was employed as a sample for the DUT used in the embodiments of the present invention. Familiarity with this device data sheet and the SDRAM's architecture, function and test techniques is assumed in the discussion below.

The BA2 pins of the input pins of the DUT's 300A and 300B are input pins used to select four memory banks in the DRAM. In the prior art, it is possible to test semiconductor memory devices having a capacity of 512 Mbytes. According to the present invention, the modified input/output printed circuit pattern allows the use of the BA2 pin and thus it is possible to test semiconductor memory devices having a capacity of 1 Gbytes. The on-die termination (ODT) pins of the DUT's 300A and 300B are pins used to open/close the termination resistance of data pins such as DQ, DQS, DQS*, RDQS, RDQS* and DM, thereby to improve signal integrity in the DRAM.

The RDQS* pins of the DUT's 300A and 300B are used by a control signal to enable reading or writing data in the DRAM. These pins only receive data from the tester into the DUT's 300A and 300B but do not transmit any input signal to the tester during the actual electric test. According to an embodiment of the present invention, this feature of the RDQS* pins is used to divide a shared or common type of the drive and comparator terminals on the test board into a separately controlled/maintained drive terminal and a comparator terminal.

According to an embodiment of the present invention, an existing test board is modified into the modified input/output printed circuit pattern, and the modified input/output printed circuit board is controlled by a test program so that the divided drive terminals are connected to the input pins of the DUT, such as BA2 and ODT, and the comparator terminals are connected to an output pin, e.g. a data strobe RDQS*. Thus, it is possible to increase the number of the pins of the devices under parallel test from 64 to 128, namely, by a multiple of 2, in the process of electrically testing the DUT's. Further, using the BA2 pin makes it possible to test DUT's having a semiconductor memory capacity increased from 512 Mbytes to 1 Gbytes.

According to the present invention, it is possible to increase the number of devices under parallel test and to test semiconductor memory devices having a larger capacity by using limited resources of an existing installed base of semiconductor testing equipment and through the modification of the test board and the test program.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A test board for a semiconductor device tester, the test board comprising:
a test board body;
a plurality of driver printed circuit patterns disposed in an area of the test board body, each of the plurality of driver printed circuit patterns for connecting a first input pin of a device under test (DUT) to a driver associated with one channel of the tester; and
a plurality of input/output printed circuit patterns disposed in another area of the test board body, each of the plurality of input/output printed circuit patterns for connecting a first output pin of the DUT to a driver and a comparator associated with one input/output channel of the tester, wherein the input/output printed circuit pattern includes a modified input/output printed circuit pattern divided into a drive terminal and a comparator terminal, the drive terminal being connected to a second input pin of the DUT and the comparator terminal being connected to a second output pin of the DUT.

2. The test board of claim 1, wherein the semiconductor device is a dynamic random access memory (DRAM).

3. The test board of claim 1, wherein the tester is a system for parallel testing a semiconductor device.

4. The test board of claim 2, wherein the second input pin is a bank active (BA) 2 pin.

5. The test board of claim 2, wherein the second input pin is an on-die termination (ODT) pin.

6. The test board of claim 1, wherein the second output pin is a data strobe (RDQS*) pin.

7. The test board of claim 1, wherein the modified input/output printed circuit pattern is connected to an input/output channel of the tester that uses only a comparator function without using a drive function in a semiconductor device testing process.

8. The test board of claim 2, wherein the modified input/output printed circuit pattern is connected to a channel that performs a data strobe (RDQS*) function of the tester.

9. A method for testing semiconductor devices, the method comprising:
forming a modified input/output printed circuit pattern in a test board configured to mount a device under test (DUT) for use with a semiconductor device tester;
constructing a test program so that a drive terminal of the modified input/output printed circuit pattern is connected to an input pin of the DUT and a comparator terminal of the modified input/output printed circuit pattern is connected to an output pin of the DUT; and
increasing the capacity of a parallel test of the semiconductor devices by a multiple of 2ⁿ, wherein n is a positive integer, by using the test board and the test program.

10. The method of claim 9, wherein the semiconductor device is a dynamic random access memory (DRAM).

11. The method of claim 9, wherein the modified input/output printed circuit pattern is connected to an input/output channel of the tester that uses only a comparator function without using a drive function in a semiconductor device testing process.

12. The method of claim 9, wherein the forming the modified input/output printed circuit pattern comprises dividing a pattern formed to be connected to a one output pin of the DUT into the drive terminal and the comparator terminal, in which one of the terminals is connected to the input pin and the other is connected to the output pin.

13. The method of claim 10, wherein the input pin is a bank active (BA) 2 pin.

14. The method of claim 10, wherein the input pin is an on-die termination (ODT) pin.

15. The method of claim 10, wherein the output pin is a data strobe (RDQS*) pin.

16. The method of claim 10, wherein using the test program comprises constructing a program to assign a pin of the DUT having two or more different functions to a single input/output channel of the tester.

17. A method for testing semiconductor devices, the method comprising:
forming a modified input/output printed circuit pattern in a test board for a semiconductor device tester;
constructing a test program so that a drive terminal of the modified input/output printed circuit pattern is connected to an input pin of the DUT and a comparator terminal of the modified input/output printed circuit pattern is connected to an output pin of the DUT; and
testing a product by using the test board and the test program, the product having a semiconductor DUT whose memory capacity is increased in a multiple of 2.

18. The method of claim 17, wherein the semiconductor device is a dynamic random access memory (DRAM).

19. The method of claim 18, wherein the input pin is a bank active (BA) 2 pin.

20. The method of claim 18, wherein the output pin is a data strobe (RDQS*) pin.

21. A test board for use with a semiconductor device tester, the test board comprising:
a test board body configured to mount a device under test (DUT) thereon, the test board body including plural DUT terminals corresponding with plural input/output (I/O) pins of the DUT, the test board body further including plural tester terminals corresponding with plural I/O pins of the semiconductor device tester;
plural printed circuit patterns on the test board body, wherein a first group of the plural patterns connect a first group of the plural DUT terminals to a first group of the plural tester terminals such that the plural printed circuit patterns of the first group connect first output pins of the DUT to a common driver/comparator associated with the tester, and wherein a second group of the plural patterns connect a first group of the plural DUT terminals to a first group of the plural tester terminals such that one or more second output pins of the DUT are connected to a separate comparator and such that one or more first input pins of the DUT are connected to a separate driver associated with the tester.

22. The test board of claim 21, wherein the tester is a system for parallel testing a semiconductor device.

23. The test board of claim 21, wherein the semiconductor device is a dynamic random access memory (DRAM).

24. The test board of claim 23, wherein at least one of the one or more second input pins is a bank active pin.

25. The test board of claim 23, wherein at least one of the one or more second input pins is an on-die termination pin.

26. The test board of claim 23, wherein at least one of the one or more second output pins is a data strobe pin.
